(19) United States
(12) Patent Application Publication
(10) Pub. No.: US 2006/0038776 A1
(43) Pub. Date: Feb. 23, 2006

(54) Ultra thin optical joystick and personal portable device having ultra thin optical joystick

(76) Inventors: Keon Joon Ahn, Sungnam-si (KR); Chul Park, Yongin-si (KR); Jae Dong Kim, Sungnam-si (KR); Jae Hun Bae, Yongin-si (KR)

Correspondence Address: LADAS & PARRY LLP, 224 SOUTH MICHIGAN AVENUE, SUITE 1600, CHICAGO, IL, 60604, US

(21) Appl. No.: 11/189,656

(22) Filed: Jul. 26, 2005

(30) Foreign Application Priority Data
Aug. 20, 2004 (KR) 20-2004-0023760
Oct. 5, 2004 (KR) 10-2004-0078941
Dec. 27, 2004 (KR) 10-2004-0113266

(51) Int. Cl. G09G 5/00

(52) U.S. Cl. 345/156

(57) ABSTRACT

An optical joystick includes a first waveguide including a first reflecting surface located below a reading area for sensing the movement of an object and a first plano-convex lens portion condensing light reflected from the first reflecting surface, a second waveguide including a second plano-convex lens portion facing the first plano-convex lens portion and a second reflecting surface for reflecting light refracted at the second plano-convex lens portion, and an image sensor located below the second reflecting surface. The first reflecting surface and the first plano-convex lens portion form a single body, and the second plano-convex lens portion and the second reflecting surface also form a single body. The reflecting surface and the lens portion are in a single body, thereby notably reducing the thickness of the optical joystick. The first and second waveguides are facing each other, thereby improving refraction and condensing light.

### CROSS REFERENCE TO RELATED APPLICATION

This application claims priority under 35 USC § 119 to Korean Patent application No. 20-2004-23760 filed on Aug. 20, 2004, Korean Patent Application No. 10-2004-78941 filed on Oct. 5, 2004, and Korean Patent Application No. 10-2004-113266 filed on Dec. 27, 2004, the contents of which are incorporated herein by reference in their entireties.

### BACKGROUND OF THE INVENTION

1. Field of the Invention

The present invention relates to an input module, and more particularly, to an ultra slim optical joystick, whose size is ultra slim, easily installed in a personal portable device such as a mobile phone and a personal portable device including the ultra slim optical joystick.

2. Description of the Related Art

In conventional personal portable devices such as mobile phones, an input module using a keypad is generally used. A conventional personal portable device includes a plurality of buttons for inputting numbers and letters so to make designated telephone numbers or sentences.

Also, a conventional personal portable device may provide various functions by using menu keys and other function keys. Recently, graphical user interface (GUI) can be shown on a display module of a personal portable device, thereby using the display module in two dimensions like a personal computer. In this case, menu keys and other function keys may be used as a direction key in order to set up and operate a wanted function.

As the function of a personal portable device is changed similar to a personal computer, however, in a personal portable device such as a mobile phone, direction keys are still used and they select one of functions or objects step by step according to finger pressing of pushing them. In spite of inconvenience of the input method using the direction keys, since a method of inputting by using a keypad is accustomed up to now and an input module can not be slim by other input method disclosed up to date, the input method using a keypad is substantially used. For example, a mobile phone should include indispensable components, such as printed circuit board (PCB) and radio frequency (RF) module. Since the size and thickness of the indispensable components in a mobile phone are considerable, there is little room for other components in addition to the indispensable components.

A conventional input method using a keypad may embody a mono movement in which telephone numbers are inputted or other menus are user one by one. Accordingly, inputting numbers or letters may get slower due to the mono movement method. Generally, a user should memorize the locations and functions of keys for a prompt input, which is troublesome. Also, the mono movement method can not fully apply the advantages of Graphical User Interface (GUI) environment in the mobile phone.

Currently, there are disclosed several pointing devices supporting GUI environment in a computer. There are a ball mouse, an optical mouse, a laser mouse, a touch pad, and a tablet in the pointing devices according to the operation method.

The pointing device used in a computer may be theoretically used as a pointing device of a personal portable device. However, since the purpose of a personal portable device is carrying, an additional pointing device separated from a main body is practically not used as a pointing device of a personal portable device.

A mouse of a trackball-type or a joystick type may be provided as a pointing device which can be installed in a personal portable device in a body. However, the structure of a trackball or joystick physically needs spatially considerable room for installation to prevent slimming down of a personal portable device.

To allow the problems, a pointing theory used in an optical mouse among the described pointing devices may be applied to a personal portable device. FIGS. 1 through 3 are cross-sectional views for illustrating the pointing theory of a conventional optical mouse.

Referring to FIG. 1, an image input device 21 used in a conventional optical mouse includes a cover glass 41, a lens 42, a shade unit 44, and an image sensor 46. Also, a light emitting diode (LED) 43 with a high brightness is used as a light source, and light emitted from the LED 43 is provided to the cover glass 41 via a light source guide 47.

In a conventional optical mouse for a PC, light is scanned toward the bottom surface from a light source, and an image sensor is located above the lens in order to sense the movement of the optical mouse. However, in order to apply a conventional optical mouse structure to a personal portable device, a finger, that is, an object moves on the cover glass, and the image sensor 46 may not move to sense the movement of the object relatively moving on the cover glass.

As shown in FIG. 1, in the conventional optical mouse structure, the cover glass 41, the lens 42, and the image sensor 46 are disposed vertically in series. That is, the image sensor is disposed at the bottom, the cover glass 41 projecting light onto the object is on the top, and the lens 42 is disposed between the cover glass 41 and the image sensor 46. The shade unit 44 is interposed between the lens 42 and the image sensor 46 to shade peripheral noise light, such that a clear image can be projected on the mage sensor 46.

Referring to FIG. 2, light generated from the LED 43 in a conventional mouse structure may be transmitted to the outside 47 of the cover glass 41 through the light source guide 45.

The transmitted light may be reflected downward by positioning an object as a finger on the cover glass 41, and the reflected light may be projected on the image sensor 46.

Referring to FIG. 3, light reflected by the object travels via the lens 42, the shade unit 44, and the image sensor 46. Light emitted from the light source is reflected by a finger 48 on the cover glass 41 to change the path, and the reflected light is projected on the optical image sensor 46 by way of the lens 42. The image sensor 46 may sense the change of the projected image and convert the image to an electric signal. The main controller of a personal portable device may interpret the movement of the object from the electric signal.

However, the image input device 21 above described can not perfectly slim a personal portable device. The shortest height of the image input device is approximately 4-5 mm in the structure of a conventional optical mouse by considering the degree of the present technology. However, the height of a module less than approximately 2 mm is required in a current personal portable device.

Since there are not only a difficulty to manufacture a ultra precision structure but also the depth of focus, the height of the image input device 21 in the structure of a conventional optical mouse can not be reduced to be less than 2 mm.

FIGS. 4 and 5 are schematic diagrams illustrating the relation between the eight and the depth of focus of an image input device.

Referring to FIG. 4, an optical system with short focal distance is illustrated. When light 62 is scanned on a lens 61, a focus is formed on an image sensor surface 63. However, in case that the distance of the focus is short, the light encounters the surface of the image sensor 63 with a high angle of incidence. Thus, if the distance between the lens 61 and the image sensor 63 gets changed, the size of a focus spot of the light 62 becomes large. If the focus spot becomes excessively large, the spot size may become larger than the pixel size of the image sensor 63. For reference, the distance between the lens 61 and the image sensor 63 is apt to be generated when assembling the input module, because of generating defects due to generation of construction tolerance.

On the other hand, an optical system with long focal distance is illustrated in FIG. 5. When light 65 is scanned on a condensing lens 64, also, a focus is formed on an image sensor surface 66. In this case, since the focal distance between the condensing lens 64 and the image sensor surface 66 is sufficiently long, the light 65 encounters the image sensor surface 66 with a low angle of incidence, almost vertically. Therefore, when the distance between the lens 65 and the image sensor surface 66 gets changed, the spot size of a focus spot is relatively small, thereby reducing or not generating defects. If construction tolerance with some degree occurs, the spot size of the focus is not larger than the pixel size of an image sensor.

Accordingly, in the structure of a conventional optical mouse, the height of basic devices is limited because a cover glass, a lens, and an image sensor are arrayed in a direction of an optical axis and the depth of focus of an optical system is limited.

### SUMMARY OF THE INVENTION

To solve the above described problems, the present invention provides an optical joystick and a personal portable device, in which numbers and letters can be inputted without an additional input module such as a mouse, when using GUI of a personal portable device.

The present invention provides an optical joystick and a personal portable device, in which a pointer on a screen is moved according to the movement of a finger moving on the joystick, and further, the height of the optical joystick is more reduced and sufficient depth of focus is provided.

The present invention provides an optical joystick and a personal portable device which can be manufactured as slim and easy to install and assemble.

According to an embodiment of the present invention, an optical joystick includes a first waveguide for refracting and condensing light reflected from an object, a second waveguide for condensing and refracting the light passing through the first waveguide, and an image sensor receiving the light refracted from the second waveguide.

The first waveguide includes a first reflecting surface located below a reading area for sensing the movement of the object and a first plano-convex lens portion. Also, the second waveguide facing the first waveguide includes a second plano-convex lens portion facing the first piano-convex lens portion and a second reflecting surface for reflecting the light refracted at the second plano-convex lens portion. Light emitted from a light source to the object is reflected due to the object. The light reflected by the object is reflected at the first reflecting surface, and the light reflected at the first reflecting surface is condensed by passing through the first and second plano-convex lens portions. The light passing through the first and second plano-convex lens portions is reflected at the second reflecting surface and forms an image on the image sensor.

Accordingly, the light reflected by the object is refracted twice, thereby providing sufficient depth of focus. Since the first and second waveguides include the reflecting surfaces and lens portions, the height of the optical joystick may be reduced to approximately 2 mm. Also, since the reflecting surface and the lens portion are one body, a waveguide may be easily manufactured and the procedure of assembling is simple to mass-produce.

According to another embodiment, an optical joystick includes a first waveguide for refracting and condensing light reflected from an object, a second waveguide for condensing the light passing through the first waveguide, and an image sensor receiving the light passing through the second waveguide.

As the previous embodiment, the first wave guide includes a first reflect surface located below a reading area for sensing the movement of the object and a first plano-convex lens portion condensing the light reflected from the first reflecting surface. The second waveguide facing the first waveguide includes a second plano-convex lens portion and may include an outlet surface without a second reflecting surface. Sufficient depth of focus may be provided by one refraction performed by the first reflecting surface, and the structure of the second waveguide may be simply maintained. Since the first and second waveguides are used, the height of the optical joystick may be reduced to approximately 2 mm. Since the reflecting surface or the lens portion is one body, the waveguide may be easily manufactured and the procedure of assembling is simple to mass-produce.

An object such as a finger is moved on a reading area, thereby designating a certain number or letter and selecting an icon in order to operate requested set up or function. There may be many methods in selecting in an optical joystick. Input may be performed by taking off a finger from a reading area or using an additional button.

### BRIEF DESCRIPTION OF THE DRAWINGS

The present invention will become more apparent to those of ordinary skill in the art be describing, in detail, exemplary embodiments thereof, with reference to the attached drawings, wherein like elements are represented by like reference numerals, which are given by way of illustration only and thus do not limit the exemplary embodiments of the present invention.

FIGS. 1 through 3 are cross-sectional views illustrating the pointing theory of a conventional optical mouse;

FIGS. 4 and 5 are schematic diagrams illustrating the relation between the height and the depth of focus of an image input device;

FIGS. 6 through 8 are cross-sectional views of an optical joystick according to an embodiment of the present invention;

FIGS. 9 through 11 are cross-sectional views of an optical joystick according to another embodiment of the present invention;

FIG. 12 is a top view illustrating the structure of a first waveguide and a second waveguide illustrated in FIGS. 6 and 9;

FIG. 13 is a cross-sectional view illustrating an optical joystick according to still another embodiment of the present invention;

FIG. 14 is a side view illustrating a waveguide of the optical joystick of FIG. 13;

FIG. 15 is a perspective view illustrating the waveguide of the optical joystick FIG. 13;

FIG. 16 is a partial perspective view illustrating the optical joystick of FIG. 13;

FIG. 17 is a perspective view illustrating the optical joystick of FIG. 13;

FIG. 18 is a top view illustrating the optical joystick of FIG. 13;

FIG. 19 is a side view illustrating the optical joystick of FIG. 13; and

FIG. 20 is a perspective view illustrating a personal portable device according to yet another embodiment of the present invention.

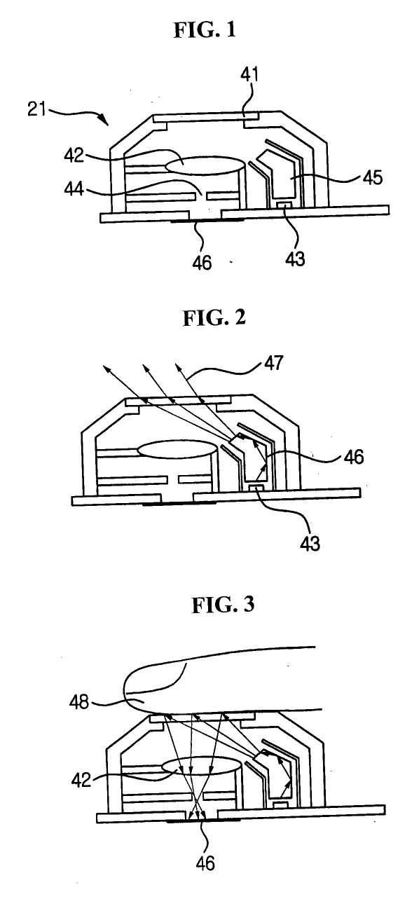

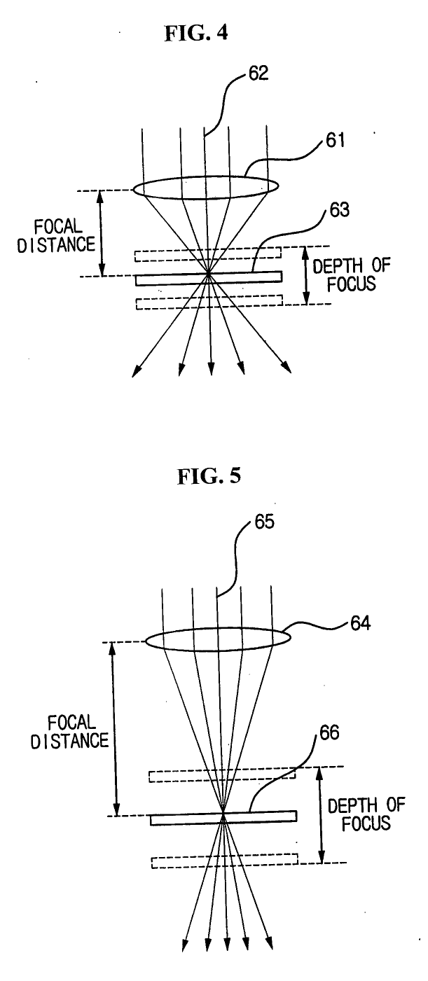

### DESCRIPTION OF THE INVENTION

Hereinafter, exemplary embodiments of the present invention will be more fully described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. Like reference numerals refer to similar or identical elements throughout.

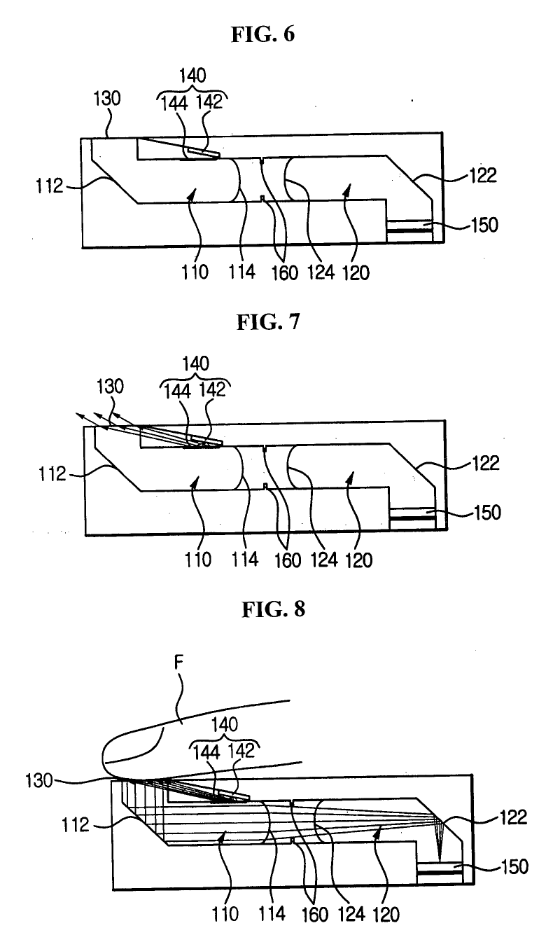

FIGS. 6 through 8 are cross-sectional views of an optical joystick according to an embodiment of the present invention.

Referring to FIG. 6, an optical joystick 100 includes a first waveguide 110, a second waveguide 120, an image sensor 150, a cover glass 130, and a light source portion 140.

The light source portion 140 includes an LED 142 and a reflecting mirror 144. Since the pixel size of the image sensor 150 included in the joystick 100 is from about 30 μm to about 50 μm, the light generated at the light source portion 140 can be sufficiently transmitted to the image sensor 150, though the light source portion 140 does not include an additional waveguide. Also, since the joystick of the present invention may be employed in a portable device such as a mobile phone, a moving zone in which a pointer is moved is substantially smaller than a general computer, thereby the light source portion 140 need not have a complicated structure for a precise pointer control.

Referring to FIG. 7, light emitted from the LED 142 as a light source is reflected by the reflecting mirror 144 and guided to the cover glass 130 with a high angle of incidence, such that the light can encounter the cover glass 130 sharply or almost horizontally. The cause of guiding the light to the cover glass 130 with the high angle of incidence is for easily scanning information on the surface shape of a finger putted on an object surface. On the other hand, light may be directly emitted from the LED 142 to the cover glass 130 without additional waveguide or reflecting mirror.

In case that there is no object on the top surface of the cover glass 130, light emitted from a light source is directly transmitted onto the top surface of the cover glass 130 and no information is transmitted to the optical image sensor 150.

Referring to FIG. 8, in case that an object as a finger F is putted on the cover glass 130, the scanned light is reflected and guided to the first waveguide 110 located below, and the light guided to the first waveguide 110 is reflected horizontally by the first reflecting surface 112.

An optical path changed horizontally progresses along the first waveguide 110 and condensed by passing through a first plano-convex lens portion 114 formed at the end of the first waveguide 1-10. The light passes through a shade unit 160 cutting off peripheral noise light and guided to the second waveguide 120.

The second waveguide 120 includes a second plano-convex lens portion 124 and second reflecting surface 122. The second plano-convex lens portion 124 and second reflecting surface 122 are one body formed of plastic for optics. The light guided to the second waveguide 120 is condensed by passing through the second plano-convex lens portion 124 and reflected downward by the second reflecting surface 122. The light is reflected by the second reflecting surface 122, thereby changing the optical path up and down.

In this case, the first or second plano-convex lens portion 114 or 124 may be a condensing lens formed in various forms such as a spherical lens or an aspherical lens shape. Also, another condensing lens or another waveguide may be interposed between the first waveguide 110 and the second waveguide 120, which may be variously changed not departing from the claims of the present invention according to the design of a designer.

The first and second waveguides 110 and 120 may be symmetrical or asymmetrical. In case that asymmetrical, the first and second waveguides 110 and 120 may have various changes in the curvature of a lens, the shape of a lens surface such as spherical or aspherical, the length of a lens, and the thickness of a lens.

Referring to FIG. 8, the light whose optical path is changed as described above is guided to the optical image sensor 150 putted on a printed circuit board (PCB) and imaged. The change of the image imaged described above is computed to compute a coordinate, thereby embodying a pointing device of an optical joystick, which makes a pointer moved on a display including LCD.

The cause of arranging the cover glass 130, the firs an second plano-convex lens portions 114 and 124, and the image sensor 150 not in the direction of an optical axis but horizontally is for applying the present invention to a portable device such as a mobile phone. Since the thickness of the portable device is very small, if each component is vertically installed, reducing the thickness may be limited due to the limit of focal distance. For example, the thickness of a module in which components are vertically formed is difficult to be reduced at most less than 4 mm.

Also, if an optical system of a condensing unit is design in order to excessively reduce the thickness, the depth of focus becomes very small, thereby deteriorating the quality of light condensed by an image sensor.

Therefore, if the optical path is changed horizontally as the present invention, a module may not only be ultra-slimmed less than approximately 2.0 mm which is substantially installed in a portable device but also obtain sufficient focal distance of approximately 5 to 30 mm to extend the depth of focus, thereby obtaining excellent workability and mass-producing.

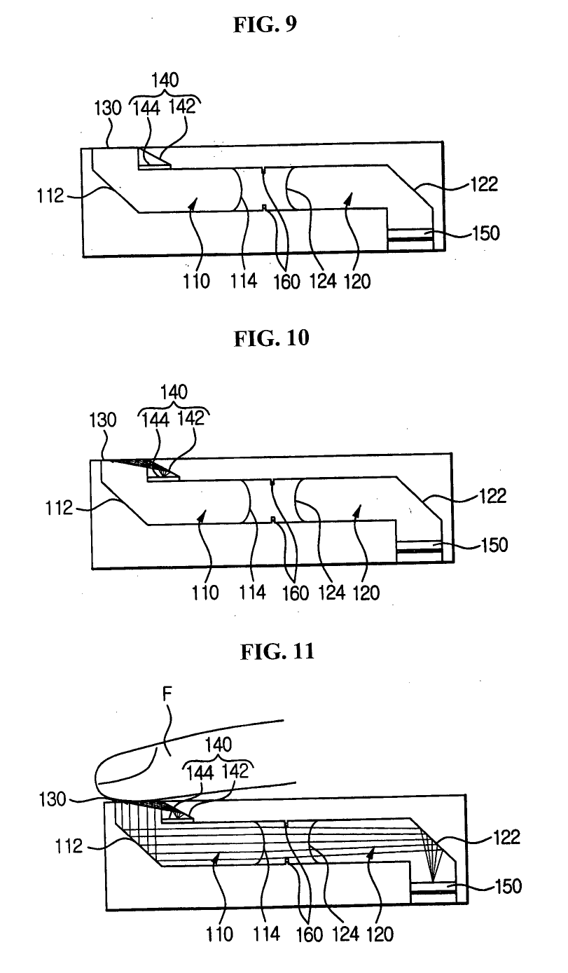

FIGS. 9 through 11 are cross-sectional views of an optical joystick according to another embodiment of the present invention.

Referring to FIGS. 9 through 11, a structure is illustrated, in which it is changed in the structure of FIG. 6 that the LED 142 is located above and the reflecting mirror 144 is inclined in order to guide light to the cover glass. In the structure, the angle and the direction of the light guided to the cover glass 130 may be easily changed, thereby easily designing an angle proper to an initial setting of a module.

In FIGS. 10 and 11, the other components excepting the light source portion 140 have the same configuration and function, corresponding to the components of the previous embodiment. In the description of the present embodiment, identical configuration may refer to the description and drawings of the previous embodiment and redundant content may be omitted.

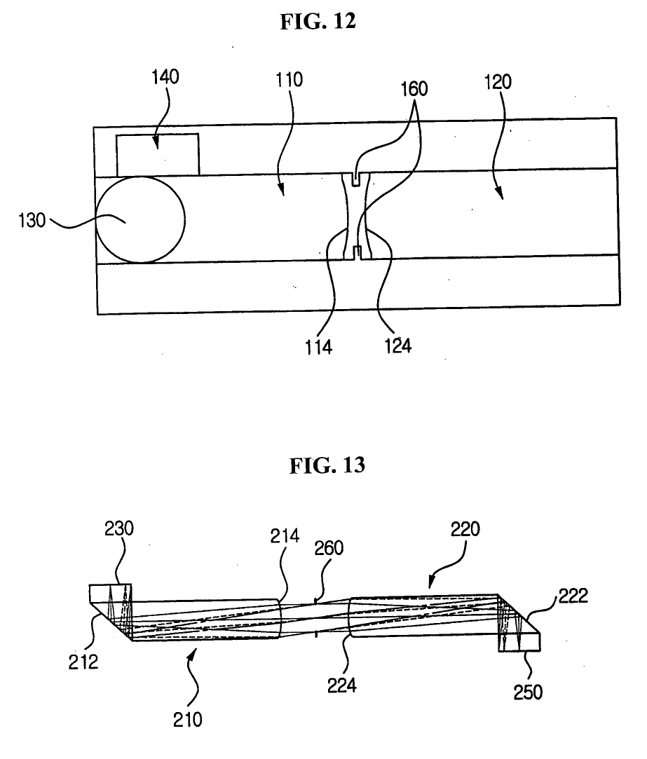

FIG. 12 is a top view illustrating the structure of a first waveguide and a second waveguide illustrated in FIGS. 6 and 9.

Referring to FIG. 12, the thickness of the first and second waveguides 110 and 120 are preferable to be approximately 2.0 mm or less, in order to apply to a portable device such as a mobile phone. However, since the width of the joystick is not restricted like the height thereof, the light source potion may be located anywhere below the cover glass 130. So, the light source portion may be located by side of the first waveguide 110 to scan light to the cover glass 130. In this case, the light may be guided to the cover glass 130 with a high angle of incidence, so to encounter the cover glass sharply, and sufficient information may be transmitted to the image sensor 150.

As described above, the present invention provides an optical joystick pointing input device in which the limit of the thickness of a conventional mouse sense module in which a cover glass, lens, and an optical image sensor are vertically disposed is solved by changing horizontally by using a reflecting surface and a condensing lens in a form of an optical waveguide, thereby embodying sufficient focal distance and the depth of focus and reducing the thickness of a module. Particularly, an ultra slim optical joystick pointing input device may be applied to a small-sized and ultra slim type device such as a mobile phone,

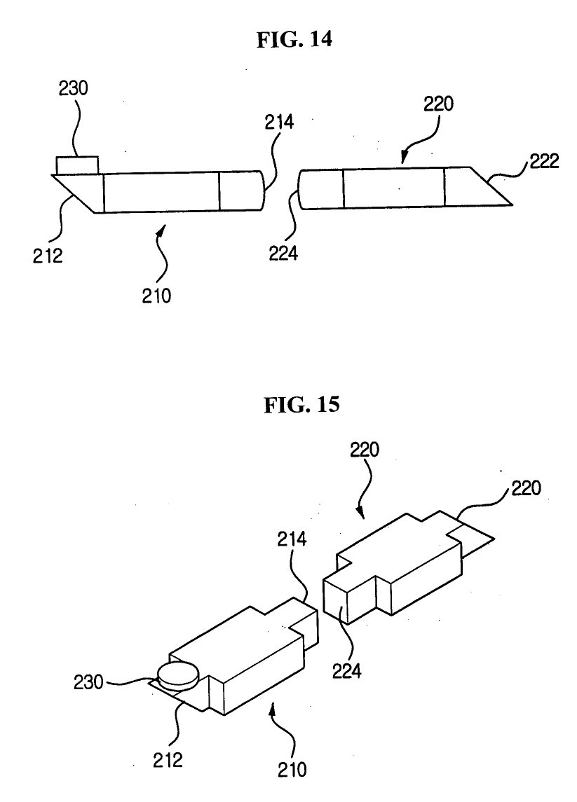

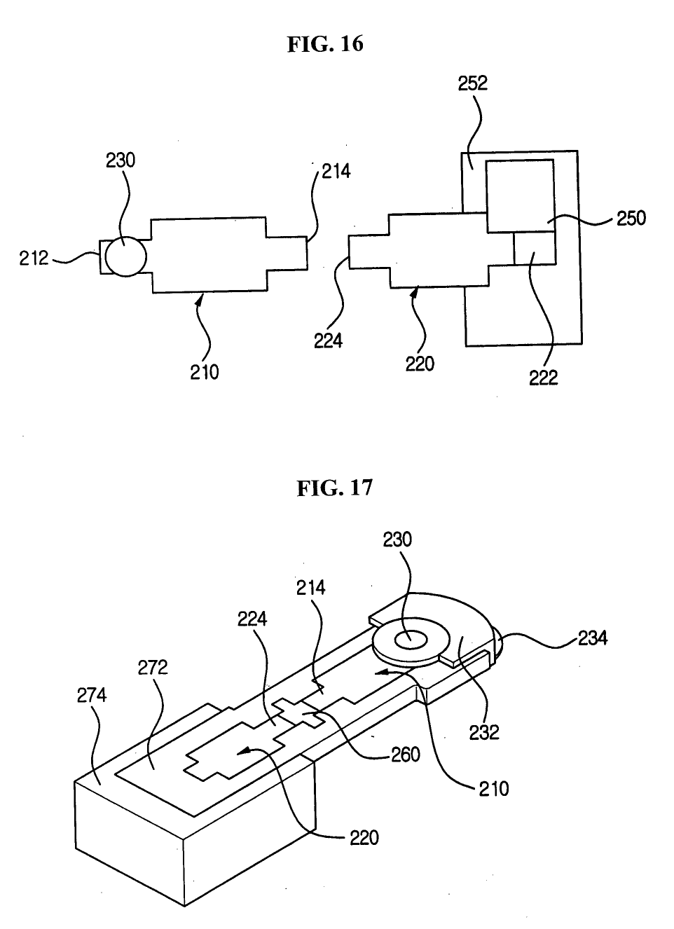

FIG. 13 is a cross-sectional view illustrating an optical joystick according to still another embodiment of the present invention, FIG. 14 is a side view illustrating a waveguide of the optical joystick of FIG. 13, FIG. 15 is a perspective view illustrating the waveguide of the optical joystick of FIG. 13, and FIG. 16 is a partial perspective view illustrating the optical joystick of FIG. 13.

Referring to FIGS. 13 through 16, an optical joystick 200 includes a cover glass 230, a first waveguide 210, a second waveguide 220, an image sensor 250, and a light source portion 240. The first waveguide 210 is a single body formed of plastic and includes a first reflecting surface 212 and a first plano-convex lens portion 214. The second waveguide 220 is also a single body formed of plastic and includes a second reflecting surface 222 and a second plano-convex lens portion 224. When light is emitted from the light 240 to an object, the light is reflected by the object and transmitted to the cover glass 230, the first reflecting surface 212, the first plano-convex lens portion 214, a shade unit 260, the second plano-convex lens portion 224, the second reflecting surface, and the image sensor 250.

The progress path of the light may be changed from a conventional vertical configuration in which the first and second plano-convex lens portions 214 and 224 and the image sensor 250 are connected to a horizontal configuration in which the light is reflected once or twice. A module in which the thickness is less than 2.0 mm and sufficient focal distance and depth of focus are provided may be formed.

Particularly, most primary factor of installing an optical joystick in a portable device such as a mobile phone is the thickness of the optical joystick. The optical path is changed horizontally, thereby reducing the length of a module to 5 to 30 mm according to the type of each small portable device such as a mobile phone in order to apply to any model.

As illustrated in FIG. 16, the image sensor 250 is installed above the PCB 252, and the center of the image sensor 250 is designed to precisely correspond to the center of the lens portion.

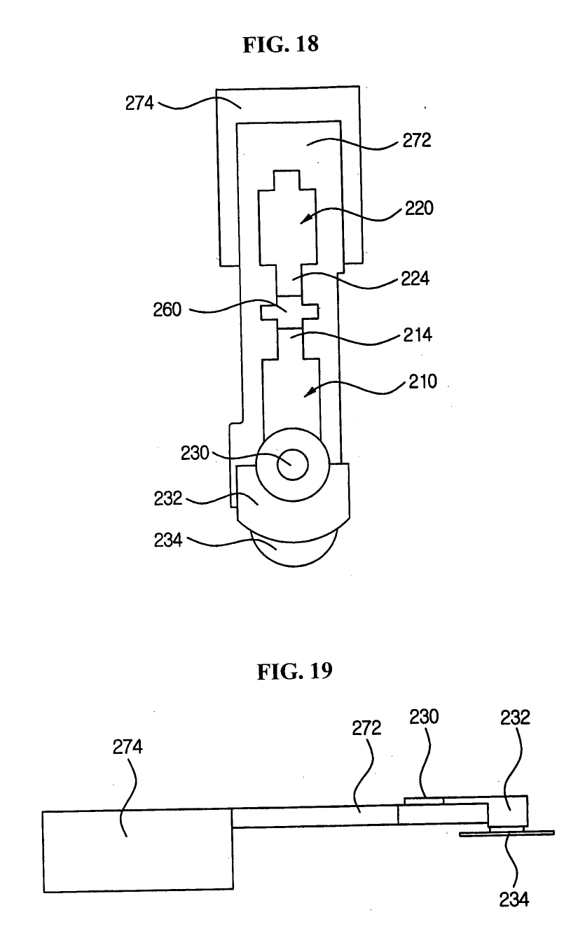

FIG. 17 is a perspective view illustrating the optical joystick of FIG. 13, FIG. 18 is a top view illustrating the optical joystick of FIG. 13, and FIG. 19 is a side view illustrating the optical joystick of FIG. 13.

Referring to FIGS. 17 through 19, an optical system, the shade unit 260, a shield section 272, a housing for fixing a PCB 252, a click button 232, and a dome switch 234 for converting the click into an electric signal are illustrated. When a finger is positioned on the top surface of the cover glass 230 and light is emitted from the LED to the cover glass, a fingerprint is recognized to recognize the intensity of light. In this case, valley and ridge of the fingerprint are recognized, thereby sensing the light and shade.

The light reflected by the object passes through the first and second waveguides 210 and 220 and guided to the image sensor 250. Information on the guided light is analyzed by the image sensor 250 and converted into an electric signal by a circuit. A pointer may be moved on a screen (not shown) including an LCD, according to the converted signal.

The present invention relates to an optical joystick which can be applied to all type of small-sized portable device such as PDAs, notebooks, and HPC. In the present specification, letters and numbers are cited. However, numbers are also designated as letters in a broad sense.

Also, the optical joystick may be used for scrolling.

A scroll indicates moving a pointer top and bottom or right and left, thereby scrolling in a desirable direction by using the movement of a finger without pushing a button. Particularly, the direction and speed of a scroll may be controlled by moving speed, direction, and distance of a finger.

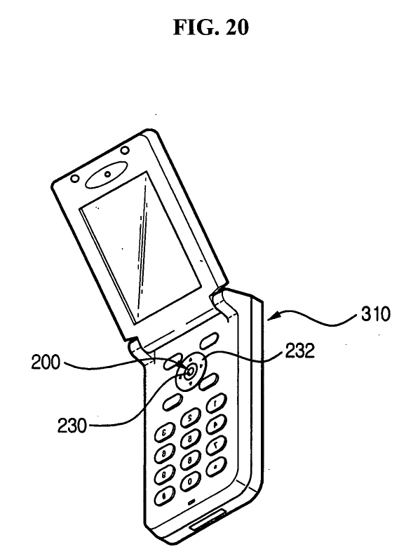

FIG. 20 is a perspective view illustrating a personal portable device according to yet another embodiment of the present invention.

Referring to FIG. 20, a personal portable device 300 includes a main body 310 and an optical joystick 200. In this case, the main body 310 includes internal and external components including general terminal function and circuit configuration. The main body 310 may include a terminal case, a keypad, a display module, a wireless transmitting and receiving module, a battery, a microphone, and a receiver. The shape of the main body 310 may be variously formed, such as a flip type, a folder type, a slide type, and a swing type.

In the present specification, a personal portable device indicates a portable electrical/electronic device such as Personal Digital Assistant (PDA), a smart phone, a handheld PC, a mobile phone, an MP3 player, may include Code Division Multiplexing Access (CDMA) module, a Bluetooth module, infrared data association, (IrDA), a wired or wireless LAN card, and may be used as a commonly called concept of a terminal with a predetermined operation ability by equipping a predetermined microprocessor performing multimedia regeneration function.

As illustrated in FIG. 20, the main body 310 includes a main part and folder part. The main part is equipped with a keypad, a battery, and a communication circuit. Also, the folder part is equipped with a display including an LCD. A menu key for setting up the function of a mobile phone is installed above the keypad. The optical joystick 200 is installed in the center of the menu key on the front of the main body 310 in order to expose the cover glass 230.

Since the click button 232 is installed around the cover glass 230 in the optical joystick 200, a user may move a pointer shown on the display by using the optical joystick 200 and embody various functions by using the peripheral click button 232.

As described above, according to the letter input method of an optical joystick according to the present invention, letters or numbers can be inputted interpreting the finger movement, though not using a keyboard. Additionally, the optical joystick of the present invention may combine with a click button to add an enter function and improve the function of inputting letters directly.

A small-sized portable device such as a mobile phone may become light, thin, and simple and input may become easy by using the method.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An optical joystick comprising:
a first waveguide including a first reflecting surface located below a reading area for sensing the movement of an object and a first plano-convex lens portion condensing light reflected from the first reflecting surface, in which the first reflecting surface and the first plano-convex lens portion form a single body;
a second waveguide including a second plano-convex lens portion facing the first plano-convex lens portion and a second reflecting surface for reflecting light refracted at the second plano-convex lens portion, in which the second plano-convex lens portion and the second reflecting surface form a single body; and
an image sensor located below the second reflecting surface.

2. An optical joystick comprising:
a first waveguide including a first reflecting surface located below a reading area for sensing the movement of an object and a first plano-convex lens portion condensing light reflected from the first reflecting surface, in which the first reflecting surface and the first plano-convex lens portion form a single body;
a second waveguide including a second plano-convex lens portion facing the first plano-convex lens portion and an outlet surface for passing light refracted at the second plano-convex lens portion, in which the second plano-convex lens portion and the outlet surface form a single body; and
an image sensor located adjacent to the outlet surface.

3. The joystick of any one of claims 1 and 2, wherein one or two of the first plano-convex lens portion and the second plano-convex lens portion are formed in a shape of a spherical or aspherical lens.

4. The joystick of any one of claims 1 and 2, wherein another waveguide including one of a lens or a lens portion is interposed between the first waveguide and second wave guide.

5. The joystick of any one of claims 1 and 2, wherein the first and second waveguides are symmetrically disposed.

6. The joystick of any one of claims 1 and 2, wherein the first and second waveguides are symmetrically disposed.

7. The joystick of any one of claims 1 and 2, wherein a cover glass is formed above the first reflecting surface of the first waveguide, the cover glass integrated in a body with the first waveguide or separately formed from the first waveguide.

8. The joystick of claim 7, wherein a light source unit is installed adjacent to the cover glass and includes a light emitting module emitting light to directly or indirectly scan light toward the cover glass.

9. The joystick of claim 8, wherein the light source unit is located below the first reflecting surface of the first waveguide such that light generated from the light emitting module passes the first reflecting surface of the first waveguide and is scanned toward the top surface of the cover glass.

10. The joystick of claim 8, wherein the light source unit includes a reflecting mirror guiding the light generated from the light emitting module to let the light encounter the top surface of the cover glass with a high angle of incidence.

11. The joystick of claim 7, wherein a light source unit is installed adjacent to the cover glass, includes a light emitting module emitting light and a light source guide guiding light generated from the light emitting module to the cover glass, in which the light source guide is formed by using plastics for optics, and guides the light from the light emitting module to the cover glass with a high angle of incidence by using total reflection.

12. The joystick of claim 7, wherein a shade unit for cutting off noise light is provided between the first and second waveguides.

13. The joystick of any one of claims 1 and 2, further comprising:
a click button formed around the cover glass;
a dome switch located beneath the click button; and
a button control section transmitting an input value of the click button.

14. A personal portable device comprising:
a terminal body including a display module;
a cover glass partially exposed from the terminal body for reading the movement of an object;
a first waveguide including a first reflecting surface located below the cover glass and a first plano-convex lens portion condensing light reflected from the reflecting surface, in which the first reflecting surface and the first plano-convex lens portion form a single body;
a second waveguide including a second plano-convex lens portion facing the first plano-convex lens portion and a second reflecting surface for reflecting light refracted at the second plano-convex lens portion, in which the second plano-convex lens portion and the second reflecting surface form a single body;
an image sensor located below the second reflecting surface; and
a control unit moving a pointer displayed on the display module according to the movement of the object read by the image sensor.

15. The device of claim 14, wherein the first and second waveguides are symmetrically or asymmetrically disposed.

16. The device of claim 14, wherein the cover glass is integrated with a body of the first waveguide or is separately formed from the first waveguide.

17. The device of claim 16, wherein a light source unit is installed adjacent to the cover glass and includes a light emitting module emitting light to directly or indirectly scan light toward the cover glass.

18. The device of claim 17, wherein the light source unit includes a reflecting mirror guiding the light generated from the light emitting module to let the light encounter the top surface of the cover glass with a high angle of incidence.

19. The device of claim 17, wherein a light source unit is installed adjacent to the cover glass, includes a light emitting module emitting light and a light source guide guiding light generated from the light emitting module to the cover glass, in which the light source guide is formed by using plastics for optics, and guides the light from the light emitting module to the cover glass with a high angle of incidence by using total reflection.

20. The device of claim 19, wherein a cut-off unit for cutting off noise light is provided between the first and second waveguides.

21. The device of claim 14, further comprising:
a click button formed around the cover glass;
a dome switch located beneath the click button; and
a button control section transmitting an input value of the click button.
